(19) United States
(12) Patent Application Publication
(10) Pub. No.: US 2010/0163481 A1
(43) Pub. Date: Jul. 1, 2010

(54) Drainage or Filter Layer for Well Screen Assembly with Integrated Stand-off Structure

(75) Inventors: Patrick W. McGrenera, The Woodlands, TX (US); Douglas W. Weeks, Cypress, TX (US); Ruediger Tueshaus, Dorsten (DE)

Correspondence Address: BURLESON COOKE L.L.P., 2040 NORTH LOOP 336 WEST, SUITE 123, CONROE, TX, 77304, US

(73) Assignee: Dorstener Wire Tech, Spring, TX (US)

(21) Appl. No.: 12/346,120

(22) Filed: Dec. 30, 2008

(51) Int. Cl. B01D 29/50; B01D 29/31

(52) U.S. Cl. 210/489; 210/497.01; 210/488

(57) ABSTRACT

An integral structure including woven wire cloth or non-woven metal filter medium for use as a drainage layer or filter layer in a well screen assembly is provided. A plurality of elongated members are welded on the woven metal cloth or non-woven metal filter medium to provide reduced resistance to flow parallel to a layer of the woven cloth. Segments of the woven or non-woven metal materials having elongated members joined thereto may be rolled into a cylinder to form a part of a well screen assembly.

### BACKGROUND OF THE INVENTION

1. Field of the Invention

This invention relates generally to well screen assemblies for wells. Specifically, a drainage or filter structure formed of metal and having an integral stand-off is provided to allow greater flow rate through a screen assembly.

2. Description of Related Art

Production of hydrocarbons such as crude or natural gas sometimes involves extraction of fluids from wells drilled through geological formations that are not consolidated into solid rock, i.e., the individual grains of mineral are free to move. Grains of minerals or clays may then flow toward the well along with produced fluids. These particles are undesirable as they may accumulate in the well to diminish flow rate from the well, abrade equipment or lead to equipment failure. If excess solid particles flow into a well, production of fluids may cease. A common practice in the industry is to provide a filter layer or layers as part of a screen structure to prevent particles entering a well. The structure or assembly is called a “well screen.” The screen may be used alone or with gravel placed in the annulus between the screen and the wall or the borehole. Significant problems with screens are that a screen may be eroded by fluid flowing on or through the screen or it may be plugged by particles in the fluid.

One common well screen structure has the filter formed by wrapping wire around the base pipe, with rods providing a standoff between the wire and the base pipe. This is the common “wire-wrapped” screen. In some screen assemblies a layer of particles such as sand grains are placed between wire-wrapping or other filter layers, forming what is often called a “pre-packed” screen assembly.

In other screen structures one or more layers of woven wire cloth are used as the filter layer, or the layer with minimum size openings. When the filter layer begins to plug, plugging will not be uniform over the screen area. Therefore, it is advantageous to provide minimum flow resistance parallel to the filter layer inside or outside the filter layer to allow pressure to become more uniform across the filter. A layer placed behind the filter to decrease resistance to flow behind a filter layer is usually called a “drainage layer.” The drainage layer will allow greater flow rate through the filter and decrease the likelihood of failure of the filter screen. In present screen assemblies, the drainage layer is usually provided by placing a coarse mesh grid behind (inside) the fine mesh filter layers.

U.S. Pat. No. 6,612,481 discloses an example of a well screen formed by sintering alternating layers of fine and coarse mesh screen together and forming a tube or cylinder, which is then placed over a mandrel. U.S. Pat. App. Pub. No. US 2006/0137883 discloses a screen structure that includes from outside to inside: a protective cover, an outer standoff layer, a filter screen, an inner standoff layer and a base pipe, as shown in FIG. 1 (Prior Art). Inner standoff layer 12 is made of orthogonally disposed metal rods welded together to form a rigid skeletal structure that insures a consistent gap between filter medium 13 and base pipe 11. Layer 12 has the purpose of allowing less resistance to flow parallel to and behind screen 13. Parts of the screen are fabricated by series resistance welding. The orthogonally disposed metal rods in layer 12 create a higher resistance to flow in the standoff layer than is preferred.

U.S. Pat. App. Pub. No. US 2008/0035330 discloses “a wire wrapped ribbed based structure” 36 that is to be used as a drainage layer or filter (FIG. 2, Prior Art). The drainage layer or filter is formed by spiral wraps of wire. Ribs 20 may be inside or outside wire 21 and the wire wraps may be longitudinally cut (22) so that the structure can be placed over a base pipe. The drainage layer is designed to be disposed between a filter layer and a base pipe.

A need exists for well screen filter layers or drainage layers formed from one or more layers of woven cloth or a non-woven metal filter medium with integral supports that provide greater area for flow of fluids inside or outside the screen when resistance to flow through the screen increases because of blockage, plugging or blinding of some areas of the screen.

### SUMMARY OF INVENTION

The problem of providing lower resistance to flow inside or outside a woven cloth layer used as a filter or drainage layer in a screen assembly is solved by providing rods or wires, which may include relief structures, welded to the woven cloth or non-woven metal filter medium in an integral structure to provide standoff from an underlying or overlying layer and higher flow area through a wire cloth layer. The integral structure may be used in a screen assembly as a filter layer or a drainage layer.

### BRIEF DESCRIPTION OF THE DRAWINGS

FIG. 1 is a cut-away perspective view of a well screen assembly disclosed in prior art.

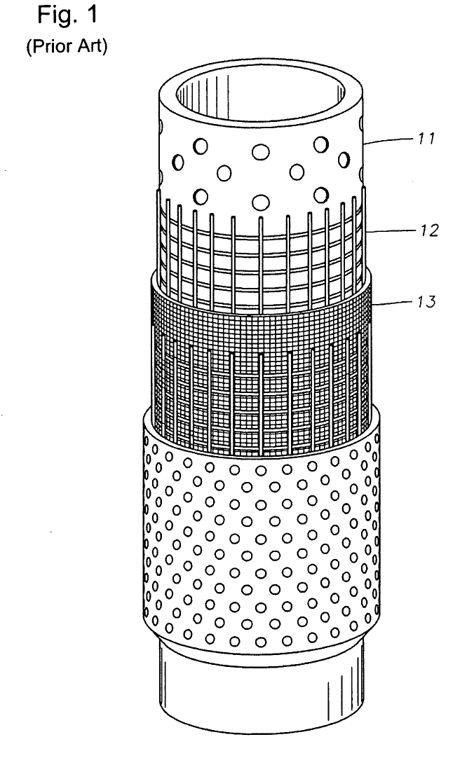

FIG. 2 is a perspective view of a wire-wrapped drainage or filter layer for a well screen assembly disclosed in prior art.

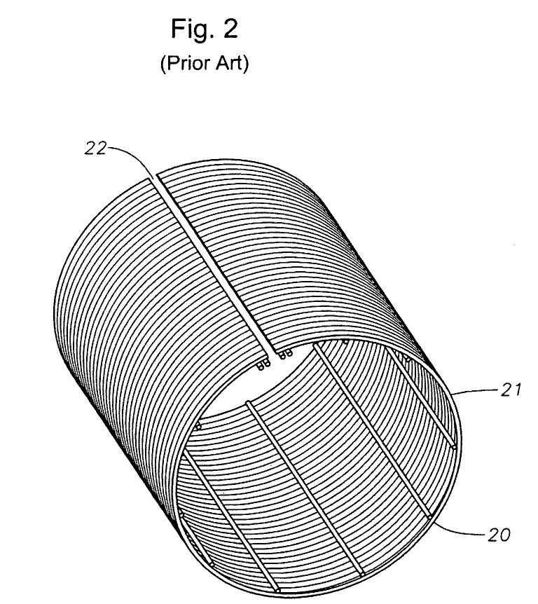

FIG. 3 is a cut-away perspective view of one embodiment of a woven cloth layer with integral drainage members disclosed herein on a base pipe.

FIG. 4 is a cut-away perspective view of woven cloth layers with integral drainage members in different directions.

FIG. 5 is a perspective view of an elongated member to be welded to a woven cloth layer.

FIG. 6 is a perspective view of another embodiment of an elongated member to be welded to a woven cloth layer.

FIG. 7 is a perspective view of a woven cloth structure in a flat configuration with overlaps before forming the structure into a cylinder.

FIG. 8 is a perspective view of the structure of FIG. 7 after forming into a cylinder.

All designations of parts having the same number are the same part in different drawings.

### DETAILED DESCRIPTION

ASTM Designation E 2016-06, titled “Standard Specification for Industrial Woven Wire Cloth” provides background information on woven wire cloth and related terminology, including definitions of terms, and it is hereby incorporated by reference herein in its entirety.

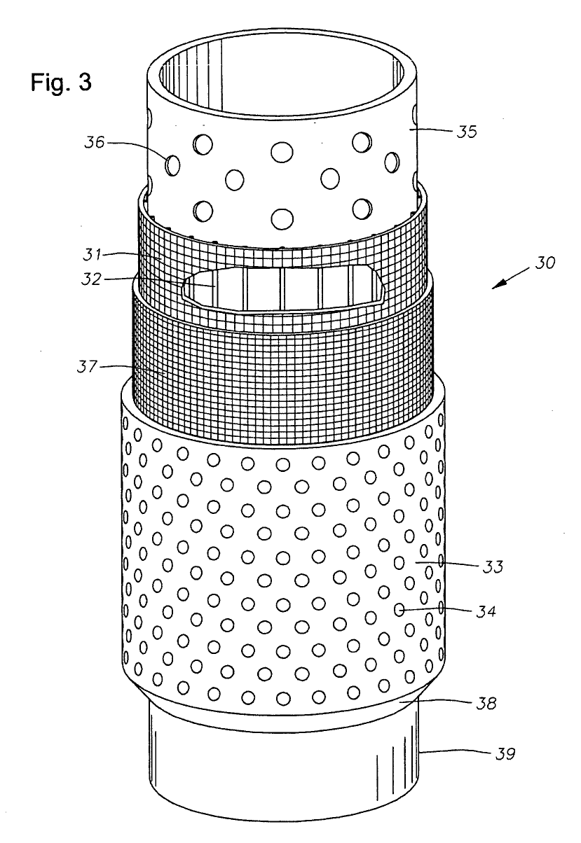

Referring to FIG. 3, a cut-away perspective view of a section of well screen assembly 30 is shown. Well screen assembly 30 may be comprised of drainage layer 31, which may be woven wire cloth or non-woven metal filter medium and elongated members 32, on base pipe 35. Ring 38 and connection 39 join screen elements to base pipe 35 and provide that a screen assembly can be joined to a tubular in a well. Drainage layer 31 supports filter layer 37. A filter layer may be a layer having smaller openings than an adjacent layer beneath or above. The adjacent layer may be designated a drainage layer. Elongated members 32 will be designated “ribs” when they are aligned axially with base pipe 35. Although ribs 32 are shown parallel to the shute or warp wires of filter layer 31, it should be understood that the warp or shute wires or woven wire cloth may be placed at any angle with respect to ribs 32. Ribs 32 are disposed between wire cloth 31 and base pipe 35, the base pipe having holes 36, so as to provide a lower resistance flow path in the axial direction between the two structures. Shroud 33, having holes 34, is preferably disposed over woven wire cloth layer 37. Shroud 33 protects metal filter layer 37 from mechanical damage.

In some embodiments, filter layer 37 or drainage layer 31 is formed from a non-woven metal filter medium. Such media include micro expanded metal, which is well known in the art. The openings in such material are normally diamond-shaped and may be selected to filter particles of selected sizes. Other non-woven metal filter media include diffusion-bonded wire cloth and random fiber cloth.

The inside diameter of the cylinder formed from drainage layer 31 is preferably sized such that elongated members 32 contact the surface of mandrel 35. Stringers 32 provide a path for fluid to flow axially to holes 36 if filter layer 37 or drainage layer 31 experiences localized plugging. The stringers also increase the mechanical strength of drainage layer 31, which is discussed further below.

Filter layer 37 or drainage layer 31 may be formed from any metal alloy that can be welded. Suitable materials for the layers include woven wire cloth made of 304 stainless steel, 316 stainless steel, 321 stainless steel, carbon steel, Inconel, and Alloy 20. The wire cloth may have a base mesh count range of approximately 1 to 635 mesh count in the warp direction and 1 to 4200 mesh count in the shute direction. The cloth wire diameters can be in the range from approximately 0.001 inch to 0.12 inch. The cloth can be selected from any mesh pattern. Suitable patterns include plain weave, twill weave, Dutch weave, twill Dutch weave, five heddle cloth, reverse Dutch weave, and reverse Dutch twill weave. Larger opening widths of the cloth will be selected for a drainage layer and smaller opening widths will be selected for a filter layer. Drainage layer 31 or filter layer 37 may be formed from different material than elongated members 32.

Elongated members 32 may range in cross-section dimensions from approximately 0.01 in. to 0.25 in. and can have a selected cross-sectional shape. Suitable shapes include circular, triangular, rectangular and other geometric shapes. Elongated members 32 provide extra stability to the cloth, and decrease the need to use multiple sintered cloth layers.

Elongated members 32 may be welded to layer 31 using several methods, including resistance welding, TIG welding and plasma welding. A preferred method is resistance welding. Elongated members 32 may be directed or mechanically guided to come into contact with cloth 31 at multiple spaced-apart locations as the cloth passes between a line of resistance electrodes having the same spaced-apart distance. Current may be adjusted to form welds that may be spaced apart along the elongated members by selected distances, for example, with spacing from about 0.001 in. to about 0.25 in. Alternatively, elongated members may be welded by a continuous seam. Elongated members 32 enhance flow and increase burst strength, collapse resistance and longitudinal loading characteristics of layer 31.

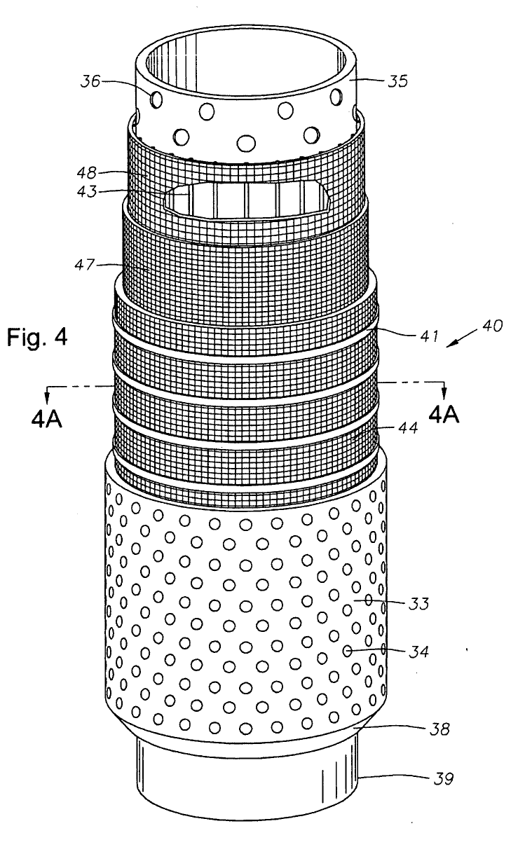

Referring to FIG. 4, a cut-away perspective view of a segment of well screen assembly 40, is shown. Layer 44 is disposed over filter layer 47. Elongated members 43 are shown welded axially along drainage layer 48 to form stringers. Elongated members 43 may be outside (not shown) or inside drainage layer 48, or both. Layer 44, filter layer 47 and drainage layer 48 may be formed using the same process as layer 31 of FIG. 3. Layer 44 has elongated members as rings 41 welded thereto. Elongated members can range in cross-sectional dimensions from approximately 0.01 in. to 0.25 in., and can have any cross-sectional shape. Suitable cross-sectional shapes for elongated members include circular, triangular, rectangular and other geometric shapes. Rings 41 will provide higher strength, especially burst and collapse strength, to screen layer 44. Strength characteristics of screen assemblies are discussed, for example, in “Collapse and Burst Test Methods for Sand Screens,” by George Gillespie, SPE 116094, Society of Petroleum Engineers, 2008. Rings such as rings 41 will substantially increase burst strength of screens, as measured by methods disclosed in the referenced Gillespie paper. Elongated members as stringers provide higher axial strength, as discussed above. Warp and shute wires may be at any angle with respect to stringers and rings. Base pipe 35 and shroud 33 were described above.

FIG. 4A shows a cross-sectional view across the section indicated in FIG. 4.

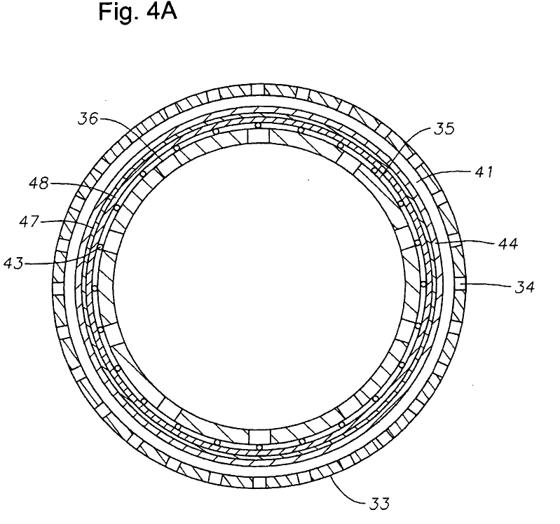

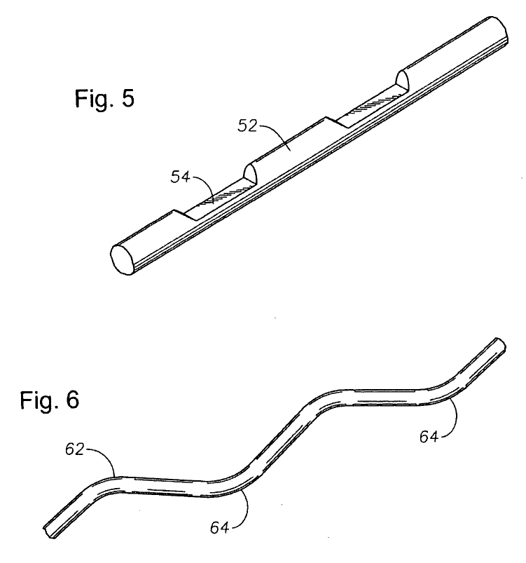

FIGS. 5 and 6 illustrate alternate embodiments of elongated members 32 of FIG. 3 or elongated members 41 of FIG. 4. FIG. 5 illustrates elongated member 52 having relief structure 54, which affords greater flow area perpendicular to the axis of the elongated member. Relief structure 54 may have any shape. For example, it may be formed simply by flattening elongated member 52 in a selected segment. Elongated members 52 may be welded to a woven cloth screen as described previously.

FIG. 6 illustrates elongated member 62, which may be pre-formed into a wave-shape suitable for welding to a woven cloth screen at segments 64 along the structure. The wave-shape may be formed by usual metal-shaping methods before the member is welded to a cloth. Other wave-shapes providing stand-off distances between segments such as segments 64 for welding may be used, including shapes having liner portions between segments 64.

Relief structures such as illustrated in FIGS. 5 and 6 provide maximum flow through the screen assembly when a shroud, filter, drainage or other outer or inner layer, such as filter layer 47 or drainage layer 48 of FIG. 4, becomes clogged or blinded in some areas. Relief structures on the inside of an outer layer can allow hydrocarbon liquid or gas to flow through the opening or openings with least flow resistance in the partially clogged or blinded outer layer and then have a path through a greater flow area in inner layer, thereby allowing maximum flow rate through the assembly. Relief structures on the outside of an inner layer, such as rings 41 of FIG. 4, can allow hydrocarbon liquid or gas to flow through the opening or openings with least flow resistance in the partially clogged or blinded inner layer because of access to greater flow area in the inner layer

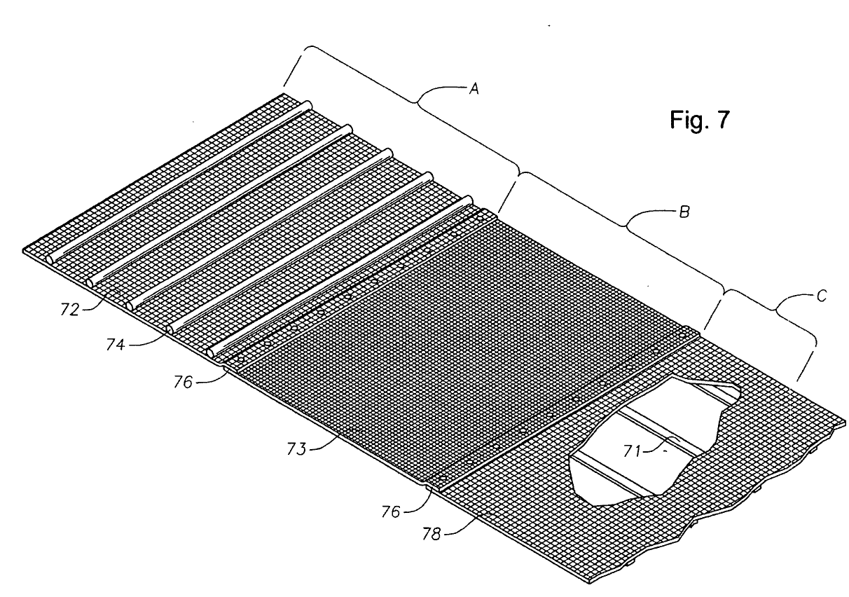

FIG. 7 shows a structure that may be used for forming well screens disclosed herein. Woven cloth 72 in the form of wide sheets or rolls, for example, having a width up to 120 inches or more, may have elongated members 74 welded to segments such as segment A. The length of segments may, for example, be in the range from about 12 inches to about 36 inches. Elongated members 74 may be guided onto screen 72 for welding by methods known in industry. Preferably, attachment of elongated members 74 to screen 72 is by resistance welding. Parameters for welding may be chosen in accord with materials, dimensions and other parameters as known in the art. Alternatively, elongated members.74 may be placed orthogonal to the directions shown in FIG. 7, in which case they become rings, as described at 41 in FIG. 4. Other segments, such as segment B and segment C, may be placed adjacent segment A. Wire cloth 73 of segment B, for example, may have smaller opening size so as to serve as a filter layer. Wire cloth 78 of segment C may have openings sized such that segment C may serve as a drainage layer. Elongated segments 71 may be in a direction so as to serve as rings, as discussed above. Overlaps 76 may be formed between segments. Segments may be welded together.

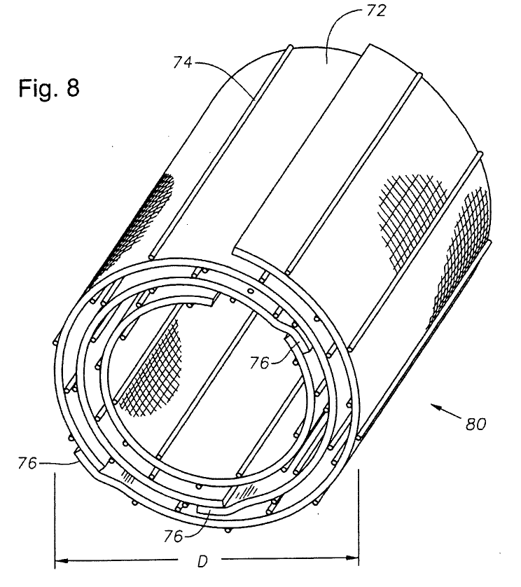

The structure of FIG. 7 may then be rolled to form cylinder 80, FIG. 8, having a selected outside diameter, D, and an inside diameter, d (not shown for clarity), selected to be placed over a base pipe or mandrel (not shown). Elongated members 74 may be on either side of wire cloth 72. Other elongated members, such as members 71 or FIG. 7, may be included in cylinder 80. Overlaps 76 may be disposed between segments of wire cloth. The cylinder may be placed in a shroud, such as shroud 33 of FIG. 3.

To form a screen assembly, metal ring 38 (FIG. 3) may be welded on the ends of cylindrical sub-assemblies, such as shown in FIGS. 3, 4 or 8, and to a base pipe having a connector for joining to other pipe.

Although the present invention has been described with respect to specific details, it is not intended that such details should be regarded as limitations on the scope of the invention, except to the extent that they are included in the accompanying claims.

We claim:

1. A structure for use in a well screen assembly, comprising:
a woven metal cloth in a cylindrical shape; and
elongated members attached to the woven metal cloth by welds.

2. The structure of claim 1 wherein the welds are disposed at spaced apart locations along the elongated members.

3. The structure of claim 1 wherein the woven metal cloth is made from 304 stainless steel, 316 stainless steel, 321 stainless steel, carbon steel, Inconel or Alloy 20.

4. The structure of claim 1 wherein the elongated members are stringers.

5. The structure of claim 1 wherein the elongated members are rings.

6. The structure of claim 1 wherein the elongated members include relief structures.

7. The structure of claim 1 wherein the elongated members are wave-shaped.

8. A well screen assembly, comprising:
a plurality of woven metal cloth segments formed into a cylinder, the segments being disposed so as to be joined or overlapping, at least one of the woven metal cloth segments having elongated members attached to the woven metal cloth by welds.

9. The well screen assembly of claim 8 wherein a first woven metal cloth segment forms a filter layer and a second woven metal cloth segment forms a drainage layer.

10. A structure for use in a well screen assembly, comprising:
a non-woven metal filter medium in a cylindrical shape; and
elongated members attached to the non-woven metal filter medium by welds.

11. The structure of claim 10 wherein the welds are disposed at spaced apart locations along the elongated members.

12. The structure of claim 10 wherein the non-woven metal filter medium is made from 304 stainless steel, 316 stainless steel, 321 stainless steel, carbon steel, Inconel or Alloy 20.

13. The structure of claim 10 wherein the elongated members are stringers.

14. The structure of claim 10 wherein the elongated members are rings.

15. The structure of claim 10 wherein the elongated members include relief structures.

16. The structure of claim 10 wherein the elongated members are wave-shaped.

17. A well screen assembly, comprising:
a plurality of non-woven metal filter media segments formed into a cylinder, the segments being disposed so as to be joined or overlapping, at least one of the metal filter media segments having elongated members attached to the woven metal cloth by welds.

18. The well screen assembly of claim 17 wherein a first non-woven metal filter medium segment forms a filter layer and a second non-woven metal filter medium segment forms a drainage layer.

19. A well screen assembly, comprising:
a plurality of segments of woven metal cloth having elongated members welded to at least one segment, the metal cloth of different segments having openings of different sizes, the segments being rolled into a cylinder such that metal cloth having openings of different sizes is radially disposed in the cylinder.

20. The assembly of claim 19 wherein the segments are joined by welding.

21. The assembly of claim 19 wherein the elongated members form rings when the segments are formed into the cylinder.

22. The assembly of claim 19 wherein the elongated members form ribs when the segments are formed into the cylinder.

23. A well screen assembly, comprising:
a plurality of segments of non-woven metal filter medium having elongated members welded to at least one segment, the non-woven metal filter medium of different segments having openings of different sizes, the segments being rolled into a cylinder such that metal filter media having openings of different sizes are radially disposed in the cylinder.

24. The assembly of claim 23 wherein the segments are joined by welding.

25. The assembly of claim 23 wherein the elongated members form rings when the segments are formed into the cylinder.

26. The assembly of claim 23 wherein the elongated members form ribs when the segments are formed into the cylinder.
